(19) United States
(12) Patent Application Publication
(10) Pub. No.: US 2009/0287383 A1
(43) Pub. Date: Nov. 19, 2009

(54) SHIFT-BY-WIRE CONTROL SYSTEM FOR VEHICLE AUTOMATIC TRANSMISSION

(75) Inventors: Naoki Fujii, Chiryu-shi (JP); Yuuichi Takamatsu, Anjo-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/465,039

(22) Filed: May 13, 2009

(30) Foreign Application Priority Data
May 14, 2008 (JP) 2008-127659

(51) Int. Cl. G06F 19/00

(52) U.S. Cl. 701/51

(57) ABSTRACT

A SBW control system is disclosed which is powered by an electric power source on a vehicle to electrically control mode shifting of an automatic transmission of the vehicle. The SBW control system includes: 1) means for inputting a shift command to shift a current operating mode of the automatic transmission to a desired operating mode; 2) means for shifting the current operating mode to the desired operating mode according to the shift command; 3) means for locking an output shaft of the automatic transmission when the desired operating mode is P (park) mode and unlocking the same otherwise; 4) means for detecting an abnormal condition of the vehicle; and 5) means for controlling the locking/unlocking means in such a manner that when the abnormal condition is detected, the output shaft of the automatic transmission is unlocked regardless of whether or not the desired operating mode is P mode.

### CROSS-REFERENCE TO RELATED APPLICATION

This application is based on and claims priority from Japanese Patent Application No. 2008-127659, filed on May 14, 2008, the content of which is hereby incorporated by reference in its entirety into this application.

### BACKGROUND OF THE INVENTION

1. Technical Field of the Invention

The present invention relates to Shift-By-Wire (SBW) control systems for automatic transmissions of motor vehicles.

2. Description of the Related Art

In recent years, there has been a growing tendency of replacing mechanical drive systems with electrical drive systems in motor vehicles, so as to meet the requirements of saving space and improving assembly efficiency and controllability. As an example, there have been developed SBW control systems which electrically control the shifting of operating modes of automatic transmissions in motor vehicles.

Japanese Patent First Publication No. 2002-243033 discloses a SBW control system for an automatic transmission of a motor vehicle, which is configured to forcibly shift the current operating mode of the automatic transmission to P (park) mode before the engine of the vehicle stops. With this SBW control system, when a shift command to shift the current operating mode of the automatic transmission to P mode is inputted by the driver of the vehicle, it is possible to prevent the current operating mode from being erroneously shifted to any other operating mode than P mode. Generally, in P mode, a parking lock is applied to the automatic transmission to lock the output shaft of the automatic transmission; in other operating modes than P mode, the parking lock is released. Therefore, with the above SBW control system, it is possible to reliably prevent the vehicle from being stolen when parked, thereby ensuring high security of the vehicle.

However, the above SBW control system can function only when it is powered by an electric power source provided on the vehicle. Therefore, when the power supply from the electric power source to the SBW control system is interrupted with the engine of the vehicle stopped, it is impossible to release the parking lock applied to the automatic transmission. Consequently, when the parked vehicle is in an abnormal condition and it is thus required to move the vehicle to another place (e.g., a repair shop), it is difficult to meet the requirement. Accordingly, the SBW control system may lack in high fail-safe capability.

### SUMMARY OF THE INVENTION

The present invention has been made in view of the above-mentioned problems.

It is, therefore, an object of the present invention to provide a SBW control system for an automatic transmission of a motor vehicle, which has high fail-safe capability as well as ensuring high security of the vehicle.

According to the present invention, there is provided a SBW control system which is configured to be powered by an electric power source on a vehicle to electrically control mode shifting of an automatic transmission of the vehicle. The SBW control system includes: 1) means for inputting a shift command from a driver of the vehicle to shift a current operating mode of the automatic transmission to a desired operating mode; 2) means for shifting the current operating mode of the automatic transmission to the desired operating mode according to the shift command inputted by the shift command inputting means; 3) means for locking an output shaft of the automatic transmission when the desired operating mode is P (park) mode and unlocking the output shaft when the desired operating mode is not P mode; 4) means for detecting an abnormal condition of the vehicle; and 5) means for controlling the locking/unlocking means in such a manner that when the abnormal condition of the vehicle is detected by the detecting means, the output shaft of the automatic transmission is unlocked regardless of whether or not the desired operating mode is P mode.

With the above configuration, when the vehicle is in a normal condition and the desired operating mode of the automatic transmission indicated by the shift command is P mode, the shifting means shifts the current operating mode of the automatic transmission to P mode and the locking/unlocking means locks the output shaft of the automatic transmission. Consequently, it is possible to reliably prevent the vehicle from being stolen when parked, ensuring high security of the vehicle. On the other hand, when the abnormal condition of the vehicle is detected by the detecting means, the controlling means controls the locking/unlocking means in such a manner that the output shaft of the automatic transmission is unlocked regardless of whether or not the desired operating mode is P mode. Consequently, even when the power supply from the electric power source to the SBW control system is interrupted due to the abnormal condition of the vehicle, it is still possible to move the vehicle to a desired place (e.g., a repair shop), thus ensuring high fail-safe capability of the SBW control system.

According to a further implementation of the invention, in the SBW control system, when the abnormal condition of the vehicle is detected by the detecting means with the current operating mode of the automatic transmission being P mode, the controlling means controls the locking/unlocking means to unlock the output shaft of the automatic transmission.

More specifically, the controlling means controls the shifting means to shift the current operating mode of the automatic transmission from P mode to N (neutral) mode, thereby causing the locking/unlocking means to unlock the output shaft of the automatic transmission.

Moreover, when the abnormal condition of the vehicle is detected by the detecting means with the current operating mode of the automatic transmission being P mode, the controlling means first determines whether a mechanical brake of the vehicle is activated. When it is determined that the mechanical brake is activated, the controlling means further controls the locking/unlocking means to unlock the output shaft of the automatic transmission.

The SBW control system further includes means for inputting an ON command to turn on an engine of the vehicle and an OFF command to turn off the engine. The locking/unlocking means unlocks the output shaft of the automatic transmission both when the desired operating mode of the automatic transmission is P mode and when the OFF command is inputted by the ON/OFF commands inputting means. When the abnormal condition of the vehicle is detected by the detecting means, the controlling means controls the locking/unlocking means in such a manner that the output shaft of the automatic transmission is unlocked regardless of whether or not the desired operating mode is P mode and whether or not the OFF command is inputted by the ON/OFF commands inputting means.

Moreover, when the abnormal condition of the vehicle is detected by the detecting means with the current operating mode of the automatic transmission being not P mode, the controlling means controls the locking/unlocking means to keep the output shaft of the automatic transmission unlocked regardless of whether or not the desired operating mode is P mode and whether or not the OFF command is inputted by the ON/OFF commands inputting means.

More specifically, the controlling means controls the shifting means to shift or keep the current operating mode of the automatic transmission to or in N (neutral) mode, thereby allowing the locking/unlocking means to keep the output shaft of the automatic transmission unlocked.

Furthermore, the SBW control system further includes means for outputting a warning. With the output shaft of the automatic transmission unlocked, the controlling means further determines whether a parking brake of the vehicle is activated or deactivated. When it is determined that the parking brake is deactivated, the controlling means controls the warning outputting means to output the warning.

In the SBW control system, when the abnormal condition of the vehicle is detected by the detecting means with the current operating mode of the automatic transmission being not P mode, the controlling means first determines whether the vehicle is stopped. When it is determined that the vehicle is stopped, the controlling means further controls the shifting means to shift or keep the current operating mode of the automatic transmission to or in N (neutral) mode, thereby allowing the locking/unlocking means to keep the output shaft of the automatic transmission unlocked.

In the SBW control system, the detecting means may detect, as the abnormal condition of the vehicle, a collision of the vehicle by checking whether an airbag of the vehicle is activated.

The detecting means may also detect, as the abnormal condition of the vehicle, a power failure in the vehicle by checking whether an output voltage of the electric power source is decreased to below a minimum starting voltage of an engine of the vehicle.

Further, the detecting means may detect the power failure in the vehicle by checking whether the output voltage of the electric power source is kept below the minimum starting voltage of the engine for longer than a predetermined time.

It is also possible for the detecting means to detect, as the abnormal condition of the vehicle, a submersion of the vehicle.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a schematic view showing the overall configuration of a SBW control system according to the preferred embodiment of the invention;

FIG. 2 is a plan view showing the configuration of a shift switch of the SBW control system;

FIG. 3 is a perspective view showing the configuration of a motion converter of the SBW control system;

FIG. 4 is a cross-sectional view taken along the line IV-IV in FIG. 3;

FIG. 5 is a flow chart illustrating a fail-safe control process for responding to a collision of the vehicle according to the preferred embodiment;

FIG. 6 is a flow chart illustrating a fail-safe control process for responding to a power failure in the vehicle according to the preferred embodiment; and

FIG. 7 is a flow chart illustrating a fail-safe control process for responding to a submersion of the vehicle according to the preferred embodiment.

### DESCRIPTION OF PREFERRED EMBODIMENT

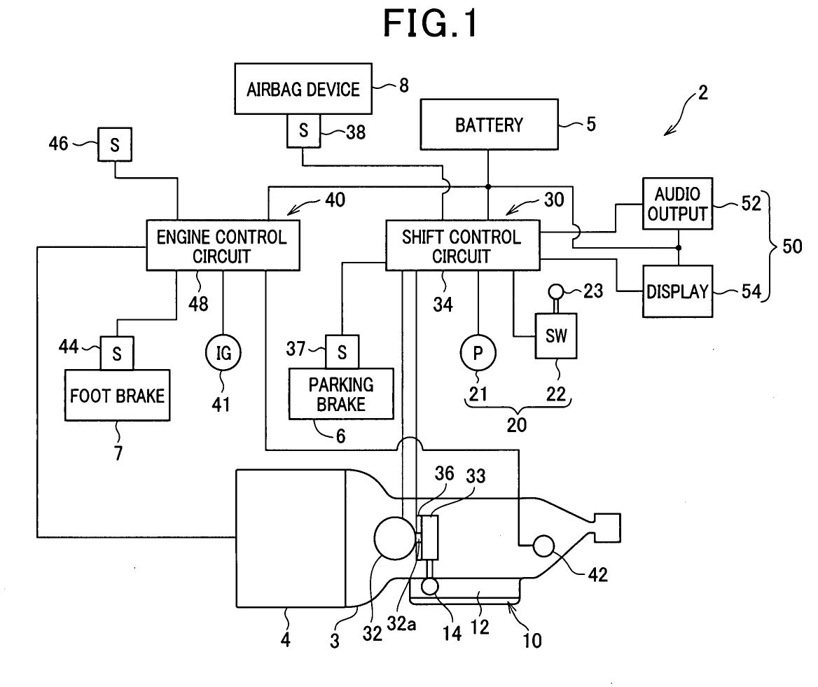

FIG. 1 shows the overall configuration of a Shift-By-Wire (SBW) control system 2 according to a preferred embodiment of the invention. The SBW control system 2 is installed, along with an automatic transmission 3 and an internal combustion engine 4, in a motor vehicle to electrically control mode shifting of the automatic transmission 3.

As shown in FIG. 1, the SBW control system 2 is made up of an automatic transmission control device 10, a mode selector 20, a shift control device 30, an engine control device 40, and a warning device 50.

The automatic transmission control device 10 includes a hydraulic circuit 12 for driving the automatic transmission 3. The hydraulic circuit 12 includes a spool valve 14 which has a spool that moves linearly. The operating modes of the automatic transmission 3 are shifted from one to another by the output hydraulic pressure of the hydraulic circuit 12 which depends on the position of the spool of the spool valve 14.

In the present embodiment, the operating modes of the automatic transmission 3 include non-transmitting modes, in each of which no torque is transmitted by the automatic transmission 3 from the engine 4 to drive wheels of the vehicle, and transmitting modes in each of which the output torque of the engine 4 is transmitted by the automatic transmission 3 to the drive wheels.

The non-transmitting modes include N (neutral) mode and P (park) mode. In N mode, the automatic transmission 3 is disconnected from the drive wheels of the vehicle so that the vehicle can move freely under its own weight. In P mode, a parking lock is applied to the automatic transmission 3, restricting the vehicle from moving in any direction.

The transmitting modes include D (drive) mode, B (brake) mode, and R (reverse) mode. In D mode, the automatic transmission 3 transmits the output torque of the engine 4 to the drive wheels of the vehicle, thereby moving the vehicle forward. In B mode, the automatic transmission 3 transmits torque from the drive wheels of the vehicle to the engine 4, thereby applying engine brake to the vehicle that is moving forward. In R mode, the automatic transmission 3 transmits the output torque of the engine 4 to the drive wheels of the vehicle, thereby moving the vehicle backward.

In addition, in the present embodiment, the position of the spool of the spool valve 14 corresponding to D mode of the automatic transmission 3 is set to be the same as that corresponding to B mode of the same. Therefore, D and B modes of the automatic transmission 3 are distinguished from one another by the operating conditions of other components in the engine 4 or in the hydraulic circuit 12 than the spool valve 14.

The mode selector 20 includes a parking switch 21 and a shift switch 22. The parking switch 21 is provided for the vehicle driver to input a shift command that commands the SBW control system 2 to shift the current operating mode of the automatic transmission 3 to P mode. The shift switch 22 is provided for the vehicle driver to input shift commands each commanding the SBW control system 2 to shift the current operating mode of the automatic transmission 3 to a corresponding one of D, B, R, and N modes. The parking switch 21 is located in the vicinity of the driver's seat in the vehicle. The shift command to shift the current operating mode of the automatic transmission 3 to P mode is inputted by a predetermined manipulation (e.g., a button manipulation or a lever manipulation) to the parking switch 21. Upon input of the shift command to shift the current operating mode of the automatic transmission 3 to P mode, the parking switch 21 generates a signal that indicates the inputted shift command. The shift switch 22 is also located in the vicinity of the driver's seat in the vehicle. Each of the shift commands to shift the current operating mode of the automatic transmission 3 to the corresponding ones of D, B, R, and N modes is inputted by a predetermined manipulation of the shift switch 22.

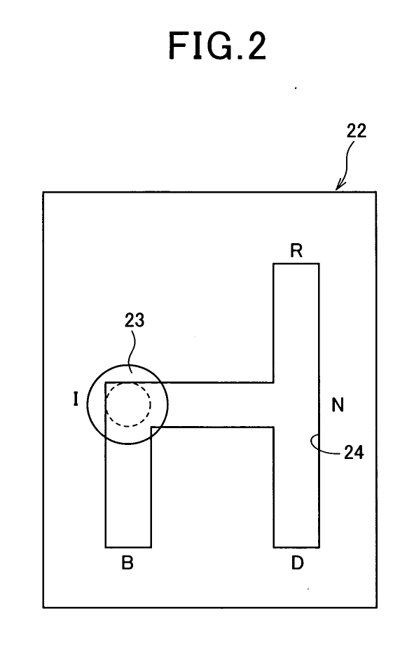

More specifically, referring to FIG. 2, in the present embodiment, the shift switch 22 includes a shift lever 23 and a shift groove 24 along which the shift lever 23 is moved. The shift lever 23 has, the shift switch 22, I (initial) position, D (drive) position that corresponds to D mode of the automatic transmission 3, B (brake) position that corresponds to B mode of the automatic transmission 3, R (reverse) position that corresponds to R mode of the automatic transmission 3, and N (neutral) position that corresponds to N mode of the automatic transmission 3. Each of the shift commands is inputted by moving the shift lever 23 along the shift groove 24 to the corresponding one of D, B, R, and N positions. Upon input of each of the shift commands, the shift switch 22 generates a signal that indicates the inputted shift command.

Referring back to FIG. 1, the shift control device 30 includes a shift actuator 32, a motion converter 33, a shift control circuit 34, and a rotational position sensor 36.

The shift actuator 32 is implemented by, for example, an electric actuator which includes an electric motor and a speed reducer. When energized, the shift actuator 32 generates torque and outputs the generated torque via a rotating shaft 32a thereof.

The motion converter 33 converts the rotational motion of the rotating shaft 32a of the shift actuator 32 into the linear motion of the spool of the spool valve 14. Consequently, with the motion converter 33, the operating modes of the automatic transmission 3 are shifted from one to another according to the rotational position of the rotating shaft 32a of the shift actuator 32.

In the present embodiment, the rotating shaft 32a of the shift actuator 32 has, in its rotational direction, P, R, N, D, and B positions which respectively correspond to P, R, N, D, and B modes of the automatic transmission 3.

In addition, as described previously, in the present embodiment, the position of the spool of the spool valve 14 corresponding to D mode of the automatic transmission 3 is set to be the same as that corresponding to B mode of the same. Accordingly, D position of the rotating shaft 32a of the shift actuator 32 is set to be the same as B position of the same.

The rotational position sensor 36 senses the rotational position of the rotating shaft 32a of the shift actuator 32 and outputs a signal that indicates the sensed rotational position. Accordingly, based on the signal output from the rotational position sensor 36, it is possible to determine the current rotational position of the rotating shaft 32a and thus the current operating mode of the automatic transmission 3. In addition, the rotational position sensor 36 may be implemented by, for example, a rotary encoder.

The shift control circuit 34 is an electric circuit which includes, for example, a microcomputer and various drivers. The shift control circuit 34 is electrically connected to a battery 5 of the vehicle, thereby being powered by the battery 5. Moreover, the shift control circuit 34 is also electrically connected to the shift actuator 32, the rotational position sensor 36, and the parking and shift switches 21 and 22 of the mode selector 20, thereby powering them using electric power supplied from the battery 5. When the vehicle is in a normal condition, the shift control circuit 34 controls, based on the signals output from the rotational position sensor 36 and the parking and shift switches 21 and 22 of the mode selector 20, the rotational position of the rotating shaft 32a of the shift actuator 32, thereby controlling the shifting of the operating modes of the automatic transmission 3.

More specifically, when the signal, which indicates the shift command to shift the current operating mode of the automatic transmission 3 to P mode, is output from the parking switch 21, the shift control circuit 34 controls the shift actuator 32 to bring the rotational position of the rotating shaft 32a sensed by the rotational position sensor 36 into agreement with P position of the rotating shaft 32a. Similarly, when any one of the signals, which respectively indicate the shift commands to shift the current operating mode of the automatic transmission 3 to the corresponding ones of D, B, R, and N modes, is output from the shift switch 22, the shift control circuit 34 controls the shift actuator 32 to bring the rotational position of the rotating shaft 32a sensed by the rotational position sensor 36 into agreement with the one of D, B, R, and N positions of the rotating shaft 32a which corresponds to the any one of the signals.

The shift control device 30 further includes a parking brake sensor 37 and an airbag sensor 38, both of which are electrically connected to the shift control circuit 34 and are thus powered by the battery 5 via the shift control circuit 34. The parking brake sensor 37 is mounted to a parking brake 6 of the vehicle which is a mechanical brake. The parking brake sensor 37 senses the operating condition of the parking brake 6 and outputs a signal that indicates the sensed operating condition. The airbag sensor 38 is mounted to an airbag device 8 of the vehicle which is activated when the vehicle has a collision. The airbag sensor 38 senses the operating condition of the airbag device 8 and outputs a signal that indicates the sensed operating condition.

The engine control device 40 includes an ignition switch 41, a speed sensor 42, a foot brake sensor 44, a submersion sensor 46, and an engine control circuit 48.

The ignition switch 41 is located in the vicinity of the driver's seat in the vehicle. The ignition switch 41 is provided for the vehicle driver to input an ON command to turn on the engine 4 and an OFF command to turn off the engine 4. More specifically, each of the ON and OFF commands is inputted by, for example, a predetermined button manipulation of the ignition switch 41. Upon input of the ON command, the ignition switch 41 generates an ON signal that indicates the inputted ON command. Similarly, upon input of the OFF command, the ignition witch 41 generates an OFF signal that indicates the inputted OFF command.

The speed sensor 42 is mounted to the automatic transmission 3. The speed sensor 42 senses the running speed of the vehicle based on the rotating speed of an output shaft of the automatic transmission 3, and outputs a signal that indicates the sensed running speed.

The foot brake sensor 44 is mounted to a foot brake 7 of the vehicle. The foot brake 7 is a mechanical brake and is activated by a pedal manipulation. The foot brake sensor 44 senses the operating condition of the foot brake 7 and outputs a signal that indicates the sensed operating condition.

The submersion sensor 46 is located in the engine compartment of the vehicle along with the engine 4 and the battery 5. The submersion sensor 46 senses a submersion of the vehicle and outputs a signal that indicates the sensed submersion of the vehicle.

The engine control circuit 48 is an electric circuit which includes, for example, a microcomputer. The engine control circuit 48 is electrically connected to the battery 5, thereby being powered by the battery 5. The engine control circuit 48 is also electrically connected to the ignition switch 41, the speed sensor 42, the foot brake sensor 44, and the submersion sensor 46, thereby powering them using electric power supplied from the battery 5.

The engine control circuit 48 controls operation of the engine 4 based on the signals output from the ignition switch 41, the speed sensor 42, the foot brake sensor 44, and the submersion sensor 46. Moreover, the engine control circuit 48 is electrically connected to the shift control circuit 34 of the shift control device 30 to send the signals output from the ignition switch 41, the speed sensor 42, the foot brake sensor 44, and the submersion sensor 46 to the shift control circuit 34. In particular, when the OFF signal, which indicates the OFF command to turn off the engine 4, is transmitted from the ignition switch 41 to the shift control circuit 34 via the engine control circuit 48 in a normal condition of the vehicle, the shift control circuit 34 shifts the current operating mode of the automatic transmission 3 to P mode.

The warning device 50 includes an audio output unit 52 and a display unit 54.

The audio output unit 52 is configured with, for example, a speaker located in the vicinity of the driver's seat in the vehicle. The audio output unit 52 is electrically connected to the battery 5, thereby being powered by the battery 5. Moreover, the audio output unit 52 is also electrically connected to the shift control circuit 34, so that it can output an audio warning under control of the shift control circuit 34.

The display unit 54 is configured with, for example, a combination meter located in the vicinity of the driver's seat in the vehicle. The display unit 54 is electrically connected to the battery 5, thereby being powered by the battery 5. Moreover, the display unit 54 is also electrically connected to the shift control circuit 34, so that it can display a warning under control of the shift control circuit 34. In addition, the display unit 54 can also display the current operating mode of the automatic transmission 3 under control of the shift control circuit 34.

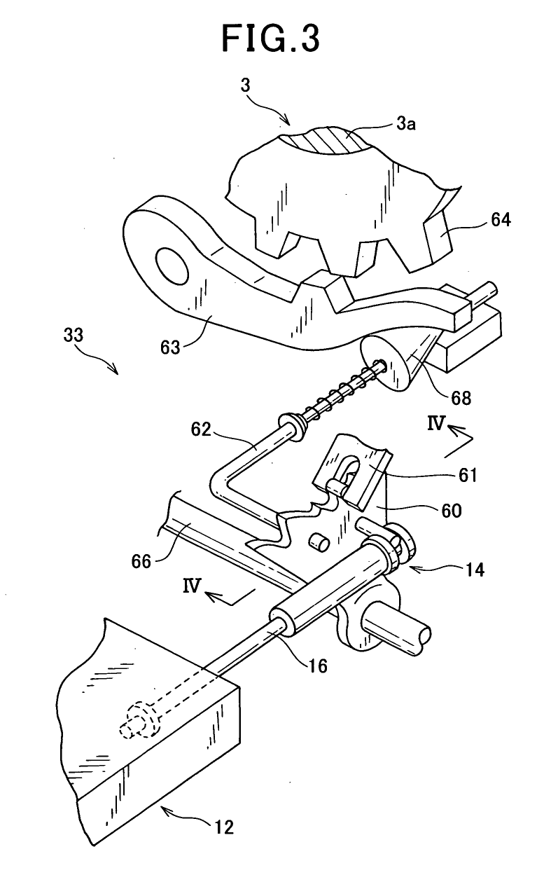

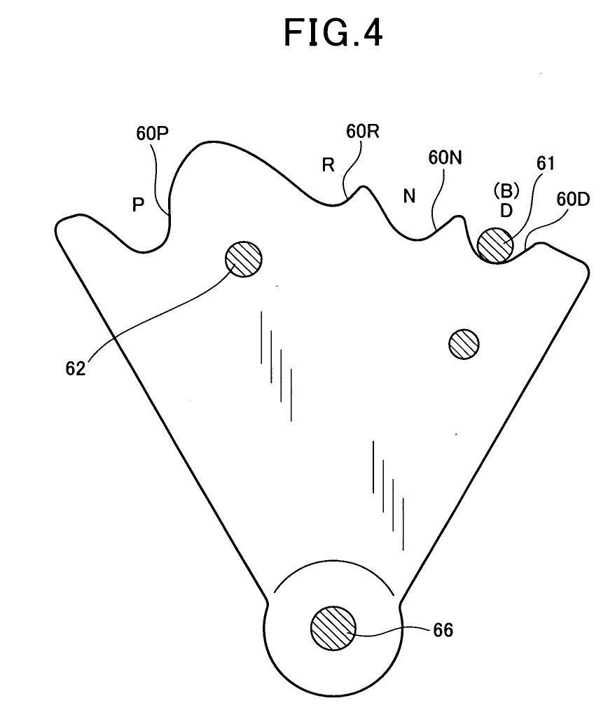

After having described the overall configuration of the SBW control system 2, the detailed configuration of the motion converter 33 of the SBW control system 2 will be described hereinafter with reference to FIGS. 3 and 4.

The motion converter 33 includes, as shown in FIG. 3, a detent plate 60, a detent spring 61, a park rod 62, a park pole 63, and a park gear 64.

The detent plate 60 has a drive shaft 66 that is fixed to the rotating shaft 32a of the shift actuator 32 (see FIG. 1). The detent plate 60 is also mechanically connected to the spool 16 of the spool valve 14 of the hydraulic circuit 12. Consequently, as the detent plate 60 is rotated by the torque output from the rotating shaft 32a of the shift actuator 32, the spool 16 of the spool valve 14 is axially moved by the detent plate 60 to shift the operating modes of the automatic transmission 3.

Moreover, as shown in FIG. 4, the detent plate 60 has four notches 60P, 60R, 60N, and 60D that are formed in the radially outer periphery of the detent plate 60 and arranged along the rotational direction of the detent plate 60. The notches 60P, 60R, 60N of the detent plate 60 respectively correspond to P, R, and N modes of the automatic transmission 3. The notch 60D of the detent plate 60 corresponds to both D and B modes of the automatic transmission 3.

The detent spring 61 is so provided as to be engageable with any one of the notches 60P, 60R, 60N, and 60D. In the rotational position of the detent plate 60 at which the detent spring 61 engages with the notch 60P, the current operating mode of the automatic transmission is shifted to P mode. Similarly, in the rotational positions of the detent plate 60 at each of which the detent spring 61 engages with a corresponding one of the notches 60R, 60N, and 60D, the current operating mode of the automatic transmission is shifted to the corresponding ones of R, N, and D modes of the automatic transmission 3.

Referring back to FIG. 3, the park rod 62 is substantially L-shaped. The park rod 62 has one end fixed the detent plate 60 and the other end on which is fixed a conical member 68 that abuts the park pole 63. The park pole 63 is so provided as to be swingable and engageable with the park gear 64. The park gear 64 is fixed on the output shaft 3a of the automatic transmission 3 which is linked to the drive wheels of the vehicle. When the park pole 63 is swung to the position at which it engages with park gear 64, the output shaft 3a of the automatic transmission 3 is locked. On the other hand, when the park pole 63 is swung to a position at which it is disengaged from the park gear 64, the output shaft 3a of the automatic transmission 3 is unlocked.

More specifically, when the detent plate 60 is rotated to the rotational position at which the detent spring 61 engages with the notch 60P, the park rod 62 is moved toward the park pole 63 and thus the park pole 63 is brought by the conical member 68 into engagement with the park gear 64, thereby locking the output shaft 3a of the automatic transmission 3 together with the park gear 64. In other words, the parking lock is applied to the automatic transmission 3. Moreover, when the detent plate 60 is rotated to any one of the rotational positions at which the detent spring 61 engages with the notches 60R, 60N, and 60D respectively, the park rod 62 is moved away from the park pole 63 and thus the park pole 63 is brought by the conical member 68 out of engagement with the park gear 64, thereby unlocking the output shaft 3a of the automatic transmission 3 together with the park gear 64. In other words, the parking lock to the automatic transmission 3 is released.

Next, fail-safe control processes of the SBW control system 2 according to the present embodiment will be described.

In the present embodiment, the fail-safe control processes include a fail-safe control process for responding to a collision of the vehicle, a fail-safe control process for responding to a power failure in the vehicle, and a fail-safe control process for responding to a submersion of the vehicle. In addition, those fail-safe control processes are performed by the shift control circuit 34 by executing predetermined programs.

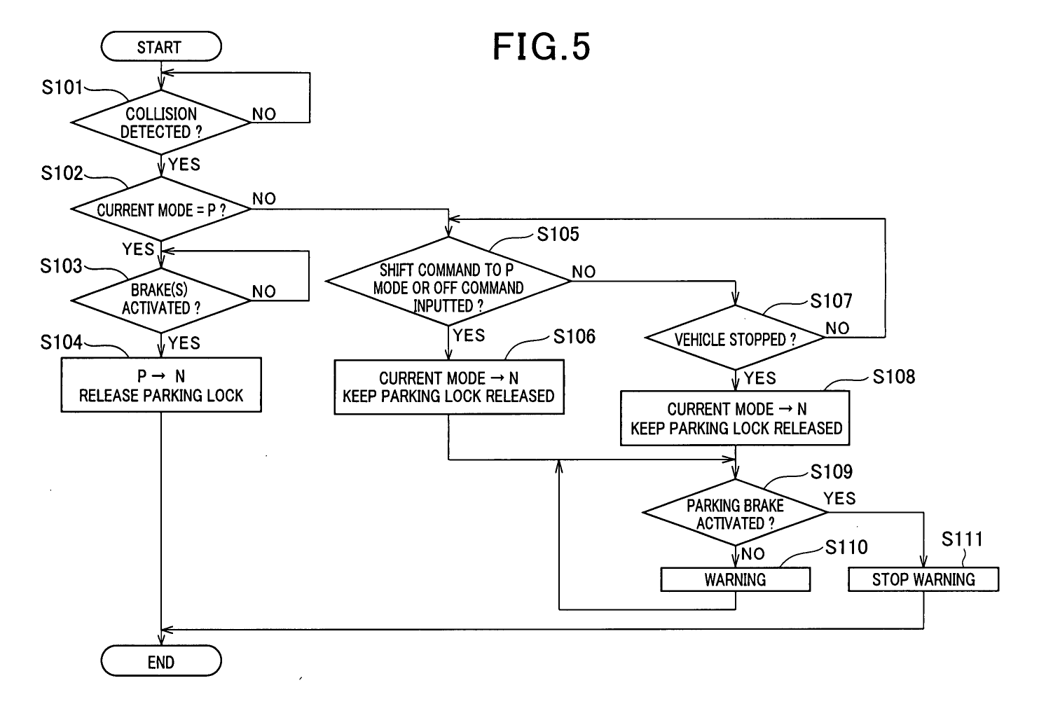

FIG. 5 shows the fail-safe control process for responding to a collision of the vehicle according to the present embodiment.

First, at step S101, the shift control circuit 34 determines, based on the signal output from the airbag sensor 38, whether a collision of the vehicle has been detected.

In addition, as described previously, the airbag device 8 is activated when the vehicle has a collision. Therefore, it is possible to determine whether a collision of the vehicle is detected based on the signal output from the airbag sensor 38 which indicates the operating condition of the airbag device 8 sensed by the airbag sensor 38.

If the determination at step S101 results in a “NO” answer, then the shift control circuit 34 repeats step S101. On the other hand, if the determination at step S101 results in a “YES” answer, then the process proceeds to step S102.

At step S102, the shift control circuit 34 further determines, based on the signal output from the rotational position sensor 36, whether the current operating mode of the automatic transmission 3 is P mode.

In addition, as described previously, the signal output from the rotational position sensor 36 indicates the current rotational position of the rotating shaft 32a of the shift actuator 32. Therefore, it is possible to determine whether the current operating mode of the automatic transmission 3 is P mode by checking whether the current rotational position of the rotating shaft 32a coincides with the P position of the rotating shaft 32a.

If the determination at step S102 results in a “YES” answer, then the process proceeds to step S103. In addition, in this case, the automatic transmission 3 is determined as being currently operating in P mode with the parking lock applied thereto.

At step S103, the shift control circuit 34 determines, based on the signals output from the parking brake sensor 37 and the foot brake sensor 44, whether at least one of the parking brake 6 and the foot brake 7 is activated.

If the determination at step S103 results in a “NO” answer, then the process repeats step S103. On the other hand, if the determination at step S103 results in a “YES” answer, then the process proceeds to step S104.

At step S104, the shift control circuit 34 controls the shift actuator 32 to bring the rotational position of the rotating shaft 32a sensed by the rotational position sensor 36 into agreement with N position of the rotating shaft 32a.

Consequently, with the at least one of the parking brake 6 and the foot brake 7 activated, the current operating mode of the automatic transmission 3 is shifted from P mode to N mode, releasing the parking lock applied to the automatic transmission 3.

In addition, at step S104, the shift control circuit 34 further controls at least one of the audio output unit 52 and display unit 54 of the warning device 50 to warn the vehicle driver of the release of the parking lock. After that, the process goes to end.

By performing above steps S103 and S104, it is possible to prevent the vehicle from starting to move by itself upon the release of the parking lock, thereby ensuring high security of the vehicle. Moreover, with the parking lock released, it is possible to move the vehicle by an external force (e.g., by a tow car) to a desired place (e.g., a repair shop) upon deactivating the activated at least one of the parking brake 6 and the foot brake 7 even when the power supply to the SBW control system 2 is interrupted due to the collision.

On the other hand, if the determination at step S102 results in a “NO” answer, then the process proceeds to step S105. In addition, in this case, the automatic transmission 3 is determined as being currently operating in one of D, B, R, and N modes with the parking lock released.

At step S105, the shift control circuit 34 determines, based on the signals output from the parking switch 21 and the ignition switch 41, whether there is inputted either of the shift command to shift the current operating mode of the automatic transmission 3 to P mode and the OFF command to turn off the engine 4.

If the determination at step S105 results in a “YES” answer, the process proceeds to step S106.

At step S106, the shift control circuit 34 controls the shift actuator 32 to bring the rotational position of the rotating shaft 32a sensed by the rotational position sensor 36 into agreement with N position of the rotating shaft 32a.

Consequently, though there is inputted the shift command to shift the current operating mode of the automatic transmission 3 to P mode or the OFF command to turn off the engine 4, the current operating mode of the automatic transmission 3, which is one of D, B, R, and N modes, is shifted to or kept in N mode, thereby keeping the parking lock released.

In addition, at step S106, the shift control circuit 34 further controls at least one of the audio output unit 52 and display unit 54 of the warning device 50 to warn the vehicle driver of the release of the parking lock. After that, the process proceeds to step S109.

By performing above steps S105 and S106, when the shift command to shift the current operating mode of the automatic transmission 3 to P mode or the OFF command to turn off the engine 4 is erroneously inputted during running of the vehicle, it is possible to keep the parking lock released, thereby preventing the running vehicle from being suddenly stopped.

On the other hand, if the determination at step S105 results in a “NO” answer, then the process proceeds to step S107.

At step S107, the shift control device 34 determines, based on the signal output from the speed sensor 42, whether the vehicle is stopped.

If the determination at step S107 results in a “NO” answer, then the process returns to step S105. On the other hand, if the determination at step S107 results in a “YES” answer, then the process proceeds to step S108.

At step S108, the shift control circuit 34 controls the shift actuator 32 to bring the rotational position of the rotating shaft 32a sensed by the rotational position sensor 36 into agreement with N position of the rotating shaft 32a.

Consequently, the current operating mode of the automatic transmission 3, which is one of D, B, R, and N modes, is shifted to or kept in N mode, thereby keeping the parking lock released.

In addition, at step S108, the shift control circuit 34 further controls at least one of the audio output unit 52 and display unit 54 of the warning device 50 to warn the vehicle driver of the release of the parking lock. After that, the process proceeds to step S109.

At step S109, the shift control circuit 34 determines, based on the signal output from the parking brake sensor 37, whether the parking brake 6 is activated.

If the determination at step S109 results in a “NO” answer, then the process proceeds to step S110, at which the shift control circuit 34 controls at least one of the audio output unit 52 and display unit 54 of the warning device 50 to warn the vehicle driver to activate the parking brake 6. After that, the process returns to step S109.

On the other hand, if the determination at step S109 results in a “YES” answer, the process proceeds to step S111, at which the shift control circuit 34 stops both the audio output unit 52 and display unit 54 of the warning device 50 from warning the vehicle driver to activate the parking brake 6. After that, the process goes to the end.

By performing above steps S106, S106, and S109, it is possible to prevent the vehicle from moving by itself with the parking lock released. Moreover, with the parking lock released, it is possible to move the vehicle by an external force (e.g., by a tow car) to a desired place (e.g., a repair shop) upon deactivating the parking brake 6 even when the power supply to the SBW control system 2 is interrupted due to the collision.

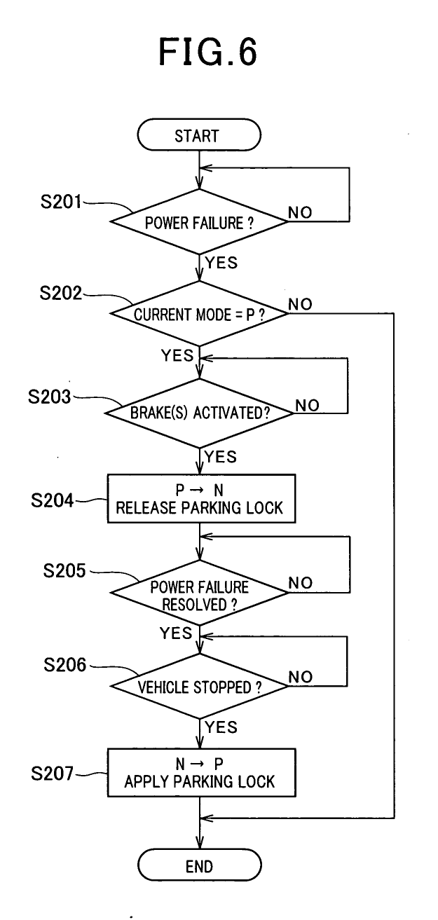

FIG. 6 shows the fail-safe control process for responding to a power failure in the vehicle according to the present embodiment.

First, at step S201, the shift control circuit 34 determines whether there is a power failure in the vehicle.

More specifically, in the present embodiment, the shift control circuit 34 determines that there is a power failure in the vehicle when the output voltage of the battery 5 is kept above the minimum operational voltage Vo of the SBW control system 2 but below the minimum starting voltage Vs of the engine 4 for longer than a predetermined time Ts. Therefore, the determination at step S201 will not produce a “YES” answer when there is a temporary drop in the output voltage of the battery due to a starting operation of the engine 4. In addition, the minimum starting voltage Vs and the time Ts are predetermined according to the specifications of the battery 5. The time Ts may be preset to, for example, one day (i.e., 24 hours).

If the determination at step S201 results in a “NO” answer, then the process repeats step S201. On the other hand, if the determination at step S202 results in a “YES” answer, then the process proceeds to step S202.

At step S202, the shift control circuit 34 further determines, based on the signal output from the rotational position sensor 36, whether the current operating mode of the automatic transmission 3 is P mode.

If the determination at step S202 results in a “NO” answer, then the process directly goes to the end. In addition, in this case, the automatic transmission 3 is determined as being currently operating in one of D, B, R, and N modes with the parking lock released.

On the other hand, if the determination at step S202 results in a “YES” answer, then the process proceeds to step S203. In addition, in this case, the automatic transmission 3 is determined as being currently operating in P mode with the parking lock applied thereto.

At step S203, the shift control circuit 34 determines, based on the signals output from the parking brake sensor 37 and the foot brake sensor 44, whether at least one of the parking brake 6 and the foot brake 7 is activated.

If the determination at step S203 results in a “NO” answer, then the process repeats step S203. On the other hand, if the determination at step S203 results in a “YES” answer, then the process proceeds to step S204.

At step S204, the shift control circuit 34 controls the shift actuator 32 to bring the rotational position of the rotating shaft 32a sensed by the rotational position sensor 36 into agreement with N position of the rotating shaft 32a.

Consequently, with the at least one of the parking brake 6 and the foot brake 7 activated, the current operating mode of the automatic transmission 3 is shifted from P mode to N mode, thereby releasing the parking lock applied to the automatic transmission 3.

In addition, at step S204, the shift control circuit 34 further controls at least one of the audio output unit 52 and display unit 54 of the warning device 50 to warn the vehicle driver of the release of the parking lock. After that, the process proceeds to step S205.

At step S205, the shift control circuit 34 determines whether the power failure has been resolved.

More specifically, in the present embodiment, the shift control circuit 34 determines whether the power failure has been resolved by checking whether the output voltage of the battery 5 has been recovered to exceed the minimum starting voltage Vs of the engine 4.

If the determination at step S205 results in a “NO” answer, then the process repeats step S205. On the other hand, if the determination at step S205 results in a “YES” answer, then the process proceeds to step S206.

At step S206, the shift control device 34 determines, based on the signal output from the speed sensor 42, whether the vehicle is stopped.

If the determination at step S206 results in a “NO” answer, then the process repeats step S206. On the other hand, if the determination at step S206 results in a “YES” answer, then the process proceeds to step S207.

At step S207, the shift control circuit 34 controls the shift actuator 32 to bring the rotational position of the rotating shaft 32a sensed by the rotational position sensor 36 into agreement with P position of the rotating shaft 32a.

Consequently, the current operating mode of the automatic transmission 3 is shifted from N mode to P mode, applying the parking lock to the automatic transmission 3. After that, the process goes to the end.

As above, in the present embodiment, when there is a power failure in the vehicle with at least one of the parking brake 6 and the foot brake 7 activated, the current operating mode of the automatic transmission 3 is shifted from P mode to N mode, thereby releasing the parking lock applied to the automatic transmission 3. Further, the parking lock is kept released until the power failure is resolved. Consequently, even when the output voltage of the battery 5 is further decreased to below the minimum operational voltage Vo of the SBW control system 2, it is still possible to move the vehicle by an external force (e.g., by a tow car) to a desired place (e.g., a repair shop) upon deactivating the activated at least one of the parking brake 6 and the foot brake 7. Moreover, since the parking lock is released with the at least one of the parking brake 6 and the foot brake 7 activated, it is possible to prevent the vehicle from starting to move by itself upon the release of the parking lock, thereby ensuring high security of the vehicle.

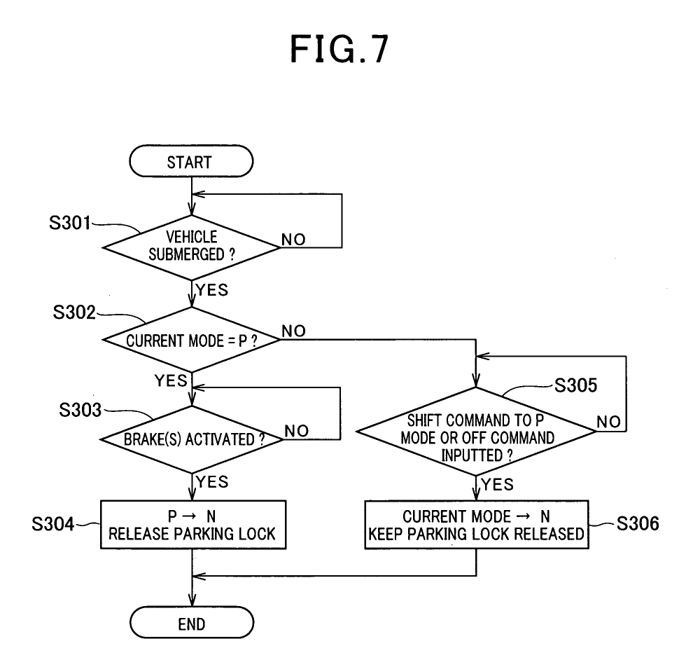

FIG. 7 shows the fail-safe control process for responding to a submersion of the vehicle according to the present embodiment.

First, at step S301, the shift control circuit 34 determines, based on the signal output from the submersion sensor 46, whether the vehicle is submerged.

If the determination at step S301 results in a “NO” answer, then the process repeats step S301. On the other hand, if the determination at step S302 results in a “YES”, answer, then the process proceeds to step S302.

At step S302, the shift control circuit 34 further determines, based on the signal output from the rotational position sensor 36, whether the current operating mode of the automatic transmission 3 is P mode.

If the determination at step S302 results in a “YES” answer, then the process proceeds to step S303. In addition, in this case, the automatic transmission 3 is determined as being currently operating in P mode with the parking lock applied thereto.

At step S303, the shift control circuit 34 determines, based on the signals output from the parking brake sensor 37 and the foot brake sensor 44, whether at least one of the parking brake 6 and the foot brake 7 is activated.

If the determination at step S303 results in a “NO” answer, then the process repeats step S303. On the other hand, if the determination at step S303 results in a “YES” answer, then the process proceeds to step S304.

At step S304, the shift control circuit 34 controls the shift actuator 32 to bring the rotational position of the rotating shaft 32a sensed by the rotational position sensor 36 into agreement with N position of the rotating shaft 32a.

Consequently, with the at least one of the parking brake 6 and the foot brake 7 activated, the current operating mode of the automatic transmission 3 is shifted from P mode to N mode, thereby releasing the parking lock applied to the automatic transmission 3.

In addition, at step S304, the shift control circuit 34 further controls at least one of the audio output unit 52 and display unit 54 of the warning device 50 to warn the vehicle driver of the release of the parking lock. After that, the process goes to end.

By performing above steps S303 and S304, the current operating mode of the automatic transmission 3 is shifted from P mode to N mode, releasing the parking lock applied to the automatic transmission 3. Further, the parking lock is kept released until the submersion sensor 46 is reset to its initial condition upon repair of the vehicle. Consequently, even when the power supply to the SBW control system 2 is interrupted due to the submersion, it is still possible to move the vehicle by an external force (e.g., by a tow car) to a desired place (e.g., a repair shop) upon deactivating the activated at least one of the parking brake 6 and the foot brake 7.

On the other hand, if the determination at step S302 results in a “NO” answer, then the process proceeds to step S305. In addition, in this case, the automatic transmission 3 is determined as being currently operating in one of D, B, R, and N modes with the parking lock released.

At step S305, the shift control circuit 34 determines, based on the signals output from the parking switch 21 and the ignition switch 41, whether there is inputted either of the shift command to shift the current operating mode of the automatic transmission 3 to P mode and the OFF command to turn off the engine 4.

If the determination at step S305 results in a “NO” answer, then the process repeats step S305. On the other hand, if the determination at step S305 results in a “YES” answer, the process proceeds to step S306.

At step S306, the shift control circuit 34 controls the shift actuator 32 to bring the rotational position of the rotating shaft 32a sensed by the rotational position sensor 36 into agreement with N position of the rotating shaft 32a.

Consequently, though there is inputted the shift command to shift the current operating mode of the automatic transmission 3 to P mode or the OFF command to turn off the engine 4, the current operating mode of the automatic transmission 3, which is one of D, B, R, and N modes, is shifted to or kept in N mode, thereby keeping the parking lock released.

In addition, at step S306, the shift control circuit 34 further controls at least one of the audio output unit 52 and display unit 54 of the warning device 50 to warn the vehicle driver of the release of the parking lock. After that, the process goes to the end.

By performing above steps S305 and S306, when the shift command to shift the current operating mode of the automatic transmission 3 to P mode or the OFF command to turn off the engine 4 is erroneously inputted during running of the vehicle in water, it is possible to keep the parking lock released, thereby preventing the running vehicle from being suddenly stopped to become unable to evacuate from water.

As described above, in the present embodiment, when the vehicle is in a normal condition, the SBW control system 2 applies the parking lock to the automatic transmission 3 upon input of the shift command to shift the current operating mode of the automatic transmission 3 to P mode or the OFF command to turn off the engine 4. Consequently, it is possible to reliably prevent the vehicle from being stolen when parked, ensuring high security of the vehicle. On the other hand, when the vehicle is in such a severely abnormal condition as to interrupt the power supply from the battery 5 to the SBW control system 2, the SBW control system 2 releases the parking lock or keeps the parking lock released. Consequently, when necessary, it is possible to move the vehicle to a desired place (e.g., a repair shop), thus ensuring high fail-safe capability of the SBW control system 2.

While the above particular embodiment of the invention has been shown and described, it will be understood by those skilled in the art that various modifications, changes, and improvements may be made without departing from the spirit of the invention.

For example, in the previous embodiment, the shift control circuit 34 performs the three fail-safe control processes for respectively responding to a collision of the vehicle, a power failure in the vehicle, and a submersion of the vehicle. However, it is also possible for the shift control circuit 34 to perform only one or two of the three fail-safe control processes.

Moreover, in the previous embodiment, in steps S103, S203, and S303 of the three fail-safe control processes, the shift control circuit 34 checks both the operating conditions of the parking brake 6 and the foot brake 7 to determine whether at least one of them is activated.

However, it is also possible for the shift control circuit 34 to check the operating condition of only one of the parking brake 6 and the foot brake 7 to determine whether it is activated.

Moreover, it is also possible to omit steps S103, S203, and S303 respectively from the three fail-safe control processes. Furthermore, steps S109 through S111 can also be omitted from the fail-safe control process for responding to a collision of the vehicle.

As the airbag sensor 38 and the submersion sensor 46, it is possible to employ those which have already existed on the vehicle, so as to minimize the manufacturing cost. Alternatively, it is also possible to additionally employ an airbag sensor and a submersion sensor dedicated to the SBW control system 2.

Furthermore, in the case of the vehicle being equipped with a communication device (e.g., a telematics device) for informing the occurrence of an abnormal condition of the vehicle, it is possible for the shift control circuit 34 to detect the abnormal condition based on a signal output from the communication device.

What is claimed is:

1. A Shift-By-Wire (SBW) control system which is configured to be powered by an electric power source on a vehicle a to electrically control mode shifting of an automatic transmission of the vehicle, the SBW control system comprising:
means for inputting a shift command from a driver of the vehicle to shift a current operating mode of the automatic transmission to a desired operating mode;
to means for shifting the current operating mode of the automatic transmission to the desired operating mode according to the shift command inputted by the shift command inputting means;
means for locking an output shaft of the automatic transmission when the desired operating mode is P (park) mode and unlocking the output shaft when the desired operating mode is not P mode;
means for detecting an abnormal condition of the vehicle; and
means for controlling the locking/unlocking means in such a manner that when the abnormal condition of the vehicle is detected by the detecting means, the output shaft of the automatic transmission is unlocked regardless of whether or not the desired operating mode is P mode.

2. The SBW control system as set forth in claim 1, wherein when the abnormal condition of the vehicle is detected by the detecting means with the current operating mode of the automatic transmission being P mode, the controlling means controls the locking/unlocking means to unlock the output shaft of the automatic transmission.

3. The SBW control system as set forth in claim 2, wherein the controlling means controls the shifting means to shift the current operating mode of the automatic transmission from P mode to N (neutral) mode, thereby causing the locking/unlocking means to unlock the output shaft of the automatic transmission.

4. The SBW control system as set forth in claim 2, wherein when the abnormal condition of the vehicle is detected by the detecting means with the current operating mode of the automatic transmission being P mode, the controlling means first determines whether a mechanical brake of the vehicle is activated, and
when it is determined that the mechanical brake is activated, the controlling means further controls the locking/unlocking means to unlock the output shaft of the automatic transmission.

5. The SBW control system as set forth in claim 1, further comprising means for inputting an ON command to turn on an engine of the vehicle and an OFF command to turn off the engine,
wherein the locking/unlocking means unlocks the output shaft of the automatic transmission both when the desired operating mode of the automatic transmission is P mode and when the OFF command is inputted by the ON/OFF commands inputting means, and
when the abnormal condition of the vehicle is detected by the detecting means, the controlling means controls the locking/unlocking means in such a manner that the output shaft of the automatic transmission is unlocked regardless of whether or not the desired operating mode is P mode and whether or not the OFF command is inputted by the ON/OFF commands inputting means.

6. The SBW control system as set forth in claim 5, wherein when the abnormal condition of the vehicle is detected by the detecting means with the current operating mode of the automatic transmission being not P mode, the controlling means controls the locking/unlocking means to keep the output shaft of the automatic transmission unlocked regardless of whether or not the desired operating mode is P mode and whether or not the OFF command is inputted by the ON/OFF commands inputting means.

7. The SBW control system as set forth in claim 6, wherein the controlling means controls the shifting means to shift or keep the current operating mode of the automatic transmission to or in N (neutral) mode, thereby allowing the locking/unlocking means to keep the output shaft of the automatic transmission unlocked.

8. The SBW control system as set forth in claim 6, further comprising means for outputting a warning,
wherein with the output shaft of the automatic transmission unlocked, the controlling means further determines whether a parking brake of the vehicle is activated or deactivated, and
when it is determined that the parking brake is deactivated, the controlling means controls the warning outputting means to output the warning.

9. The SBW control system as set forth in claim 1, wherein when the abnormal condition of the vehicle is detected by the detecting means with the current operating mode of the automatic transmission being not P mode, the controlling means first determines whether the vehicle is stopped, and
when it is determined that the vehicle is stopped, the controlling means further controls the shifting means to shift or keep the current operating mode of the automatic transmission to or in N (neutral) mode, thereby allowing the locking/unlocking means to keep the output shaft of the automatic transmission unlocked.

10. The SBW control system as set forth in claim 9, further comprising means for outputting a warning,
wherein with the output shaft of the automatic transmission unlocked, the controlling means further determines whether a parking brake of the vehicle is activated or deactivated, and
when it is determined that the parking brake is deactivated, the controlling means controls the warning outputting means to output the warning.

11. The SBW control system as set forth in claim 1, wherein the detecting means detects, as the abnormal condition of the vehicle, a collision of the vehicle by checking whether an airbag of the vehicle is activated.

12. The SBW control system as set forth in claim 1, wherein the detecting means detects, as the abnormal condition of the vehicle, a power failure in the vehicle by checking whether an output voltage of the electric power source is decreased to below a minimum starting voltage of an engine of the vehicle.

13. The SBW control system as set forth in claim 12, wherein the detecting means detects the power failure in the vehicle by checking whether the output voltage of the electric power source is kept below the minimum starting voltage of the engine for longer than a predetermined time.

14. The SBW control system as set forth in claim 1, wherein the detecting means detects, as the abnormal condition of the vehicle, a submersion of the vehicle.
